(19) United States
(12) Patent Application Publication
(10) Pub. No.: US 2012/0203864 A1
(43) Pub. Date: Aug. 9, 2012

(54) Method and Arrangement in a Communication Network for Selecting Network Elements

(75) Inventors: Gábor Tóth, Szigetszentmiklos (HU); Lars Westberg, Enkoping (SE)

(73) Assignee: TELEFONAKTIEBOLAGET L M ERICSSON (PUBL), Stockholm (SE)

(21) Appl. No.: 13/502,247

(22) PCT Filed: Oct. 23, 2009
(86) PCT No.: PCT/SE09/51218

§ 371 Date: Apr. 16, 2012

(51) Int. Cl. G06F 15/16

(52) U.S. Cl. 709/217

(57) ABSTRACT

An arrangement and method for selecting one or more network elements of a communication network from which a requested content is to be downloadable to a requesting host is based on an enhanced DNS functionality which is adapted to provide an optimized network element selection. A received address resolving request results in a process for selectively identifying and acquiring topology related network information, which is using the acquired information as a basis for selecting one or more network elements. Addresses are then resolved for the selected network element/s, and the obtained addresses are provided to the requesting host in response to the request.

### TECHNICAL FIELD

The present invention generally relates to a method and arrangement for selecting one or more network elements from which required content can be downloaded.

### BACKGROUND

A steadily increasing use of services which enable various types of content to be accessed via the Internet continuously raises the demand for more efficient mechanisms for selecting the most appropriate source for the downloadable content.

A typical network architecture 100, according to the prior art, which enables users to download content to a respective user device over the Internet may be illustrated according to the simplified overview of FIG. 1, where three user devices, referred to as user device 1, user device 2 and user device 3 can download downloadable content from one or more of a plurality of network nodes, here represented by server 1, server 2, server 3 and server 4, via a respective access node 101,102,103 and one or more switches 104,105, 106, 107.

FIG. 1 illustrates a typical scenario where a user being registered to a user device, such as e.g. user device 1, may request a movie that is downloadable from one or more of servers 1,2,3 or 4, which in this particular case may be Video on Demand (VoD) servers, which have been configured to enable streaming of movies to a user device on demand, i.e. whenever a movie is required by the user. Such services, which may involve a large number of servers and/or downloadable items will require efficient access procedures.

In order to be able to access the requested movie user device 1 has to have in its possession at least one IP address to a VoD server from which the required movie can be distributed. A movie, as well as other types of downloadable content, may be distributed from one single server, or as separate parts, each of which is accessible from different servers, wherein the different parts are then combined when consumed. In the latter case, instead of just one IP address, a list of IP addresses will be required at the user device. Once in possession of the one or more required IP addresses, downloading from one or more servers may commence in a more or less efficient way, to a large extent depending on the selected path, via which the content is distributed to the user device.

IP-addresses can be obtained by performing address resolving, which can be executed by forwarding a query to a Domain Name System (DNS), which is a hierarchical naming system to be used for resources connected to the Internet or a private network. DNS associates various information with domain names and translates computer hostnames such as e.g. “www.myshop.com” into IP addresses such as e.g.303.23.564.984.

Current solutions for acquiring the relevant IP-address/es, resides on a set of pre-configured IP-addresses that is generated per query. In response to a query, a list of alternative IP-addresses from, or via which, the required content can be accessed, is sent to the originator of the query, which may be the user device on which the required content is to be consumed, or another entity, operating on behalf of the user device. From hereinafter the device or network node which initiates such a query will be referred to as a requesting host. The requesting host typically selects an IP-address out of the ones acquired in the list by using a pre-specified selection algorithm.

The commonly known concept of DNS based pooling, which may also be referred to as network-based selection, is a concept which is based on statically configured pools of network nodes, where the configuration of different pools is done in one single place, namely in a DNS server. The configuration is static, since it does not entail any dynamic selection process.

A requesting host sends a DNS query to the DNS. In return the host obtains a list of IP-addresses to a pool of network nodes. The requesting host then selects one of the IP-addresses from the list (or a plurality of addresses if downloading from more than one network node is required), on the basis of a pre-defined internal selection algorithm. There is some limited selection intelligence available that may be added to a DNS based solution in order to provide a more efficient selection.

“Sort List” is one known DNS feature which enables the order of addresses in a DNS query response to be ordered on the basis of the source address of a query. A disadvantage with using Sort Lists in a DNS server is that there is no guarantee that the original order will always be maintained as information is passed from one DNS server to another. To ensure that the order is properly maintained Sort List need to be configured in all the DNS servers in a network, thereby adding considerable complexity to large DNS solutions. In some situations it may even be impossible to set Sort List on all DNS servers.

“Round Robin” is another DNS feature which can be used for balancing the traffic between two or more IP-addresses. Round Robin is commonly used in GPRS for distributing the load between multiple GGSNs. Like most DNS features, Round Robin operates using static information in the DNS database. Dynamic information, such as e.g. status of and/or the actual load on a network node are however not taken into consideration when the DNS server is responding to a DNS query. Round Robin may override the structure of a response sent from an authoritative server, or the effect of a Sort List.

DNS also enables service-specific selection through the usage of the so-called Resource Records (RR). In a basic DNS server, such as e.g. the one described in “IETF RFC 1034/1035”, pools can be configured with multiple address RRs for a given host name. The DNS server then returns, upon a DNS query, all RRs matching the query. Choosing IP-address associated with a certain network node out of the retrieved IP addresses is later done by the requesting host.

An even more enhanced service-based pooling solution is specified in “RFC 2782: The SRV RR enabled DNS server”, which refers to a solution where pools can be configured via multiple service resource records (SRV RRs) for a specific service, such as e.g. a content downloading service. A RR format also includes priority and weight parameters, which enables a DNS servers DNS query answer to contain all possible choices with priority and weight information, leaving the selection of network node to the requesting host. Such a selection is typically done according to pre-defined rules, e.g. on the basis of the received priority and weight parameters.

### SUMMARY

One problem with the currently known pooling solutions is that they are static, thereby failing to take network system related changes into consideration.

Another problem by using any of the described solutions is that the source IP-address exposes the internal topology of the network, whereas topology hiding is one of the requirements in the IMS system for use of Session Border GWs.

It is therefore an object of the invention to address at least some of the problems outlined above. More specifically it is an object of the present invention to provide an extended address resolving mechanism where a selection of the one or more most appropriate network element/s is executed, in addition to just performing address resolving for one or more network elements and providing the resulting addresses to a requesting host.

According to different aspects, an arrangement, a method and a computer program product are provided to enable realization of the suggested address resolving concept.

According to one aspect, an arrangement in a communication network for providing one or more addresses associated with one or more networks of one or more network elements from which a requesting host is able to download a requested content, is disclosed. The arrangement, which is associated with a DNS server functionality, is adapted to perform an optimized network element selection in association with performing the requested address resolving.

The arrangement comprise a communication unit, which is adapted to receive an address resolving request from a requesting host, where the request comprises request specific information on the requested content and the requesting host. The arrangement also comprise a network database, containing topology related network information on the communication network, an identifying unit, adapted to identify a subset of the network information on the basis of the received request specific information, and a selecting unit.

The selecting unit is adapted to combine address resolving with a selection mechanism, where the selecting unit first acquires the identified subset of network information, after which one or more network elements are selected on the basis of the acquired subset of network information and the request specific information. Finally the selection unit resolves one or more addresses for each of the one or more network elements.

The communication unit is further adapted to transmit the one or more addresses to the requesting host in a response message.

According to one embodiment, the identifying unit of the suggested arrangement is adapted to identify a topological location of the requesting host on the basis of the request specific information, while the selecting unit is adapted to select the one or more network elements at least partly on the basis of the topological location.

The network information may comprise one or more of: subscription related information associated with the requesting host; service related information associated with the requesting host; information related to at least one of said one or more network elements from which a requested content is downloadable, and capability and link status related information of the available transport nodes.

According to one alternative embodiment, the selecting unit is adapted to select the one or more network elements by executing pre-defined selection criteria, using the acquired subset of network information as input data.

According to yet another embodiment, the arrangement also comprises a monitoring unit that is adapted to acquire topology related network information associated with the communication network and to update the network database. The monitoring unit may comprise one or more of: a topology discovery function, which is adapted to acquire changes to at least one of: routing topology information and link status information on transport nodes of the communication network; a supervision function, which is adapted to acquire changes to at least one of: status, capability, functionality and load information on the transport nodes and network elements of the communication network, and a resource administration function, which is adapted to acquire updated transport resource information on the transport nodes of the communication network.

The selecting unit may be adapted to base the selection of network element/s on a number of different criteria, either alone or in a combination.

According to one alternative, the selecting unit is adapted to calculate, based on the identified subset of network information, the number of hops required for downloading the requested content, and base the selection on the number of hops required for downloading the requested content.

According to another alternative, the selecting unit is adapted to calculate, based on the identified subset of network information, the delay in connection to the downloading of the requested content, and base the selection on the delay in connection to the downloading of the requested content.

According to yet another alternative, the selecting unit is adapted to calculate, based on the identified subset of network information, the load of the network elements, and base the selection on the load of the network elements.

The selecting unit may also be adapted to calculate, based on the identified subset of network information, the capacity of the network elements, wherein the selection is based on the capacity of the network elements.

In addition, the selecting unit may base the selection of network element/s on the coding quality of the requested content downloadable from the network elements and/or on additional content that may be downloadable from the network elements. The latter selection criterion may be applied in situations where advertisements are to be distributed together with the requested content, and in such a situation, the additional content may constitute yet another criterion to take into consideration when the one or more most preferred network elements are to be selected.

Furthermore, the selecting unit may be adapted to sort the one or more resolved addresses in a pre-selected order.

If the requested content is a movie, the one or more network elements from which to select may be Video on Demand (VoD) servers.

According to another aspect, a method in an arrangement of a communication network for providing, to a requesting host, one or more network elements, from which the requesting host is able to download a requested content, is disclosed.

The method which is performed in association with a DNS server functionality, is adapted to perform the address resolving in association with performing an optimized selection of the one or more network elements.

In response to receiving an address resolving request from a requesting host, where the request comprise request specific information on the requested content and the requesting host, the arrangement identifies a subset of network information from topology related network information stored on a network database, on the basis of the received request specific information. The identified subset of network information is then acquired from the network database, and on the on the basis of the acquired subset of network information and the request specific information, one or more network elements are selected.

With one or more network elements selected, one or more addresses are resolved for each network element, and the resolved addresses are then transmitted to the requesting host in a response message.

According to one alternative embodiment, the method also comprises the steps of dynamically acquiring topology related network information associated with the network and updating the network database, accordingly.

More specifically, the step of identifying the subset of network information may comprise acquiring the topological location of the requesting host, wherein the selecting step may comprise selecting the one or more network elements at least partly on the basis of the topological location.

The method steps of selecting one or more network elements may be based on a wide range of different selection criteria, each of which may be applied alone or in a combination, e.g. as suggested above.

The suggested method may be used in association with requesting for any type of downloadable content, such as e.g. a movie, a game, one or more executable programs, a piece of music, a painting, a photograph, or a piece of literature.

According to yet another aspect a computer program product directly loadable into a memory means of an arrangement comprising software code portions for performing a method such as the one described above when the computer program product is run on the arrangement is also provided.

By enhancing the address resolving process, which is commonly performed in association with requesting for downloadable content, with an advanced selection procedure, for selecting the most appropriate network elements from which the content may be downloaded, the downloading process may be simplified at the requesting host.

Another benefit from applying the requested method is that the request procedure can be speeded up, since in addition to receive relevant addresses, a requesting host may use the retrieved addresses instantly, without having to execute any further selecting processing.

Further possible features and benefits of the suggested invention will become apparent from the detailed description below.

### BRIEF DESCRIPTION OF THE DRAWINGS

The present invention will now be described in more detail with reference to exemplary embodiments and to the drawings, of which:

FIG. 1 is an overview of a network architecture, according to the prior art.

FIG. 2 is a basic overview of an arrangement which is adapted to enhance a conventional DNS server, according to one exemplified embodiment.

FIG. 3 is a basic overview of a monitoring unit suitable for implementation in an arrangement according to FIG. 2.

FIG. 4a is a general flow chart illustrating method steps for selecting one or more network elements at an arrangement according to the one described with reference to FIG. 2.

FIG. 4b is a flow chart illustrating monitoring and updating steps to be executed in parallel to the method steps of FIG. 4a.

FIG. 5 is a flow chart illustrating how the selecting step of FIG. 4a may be executed according to one alternative embodiment.

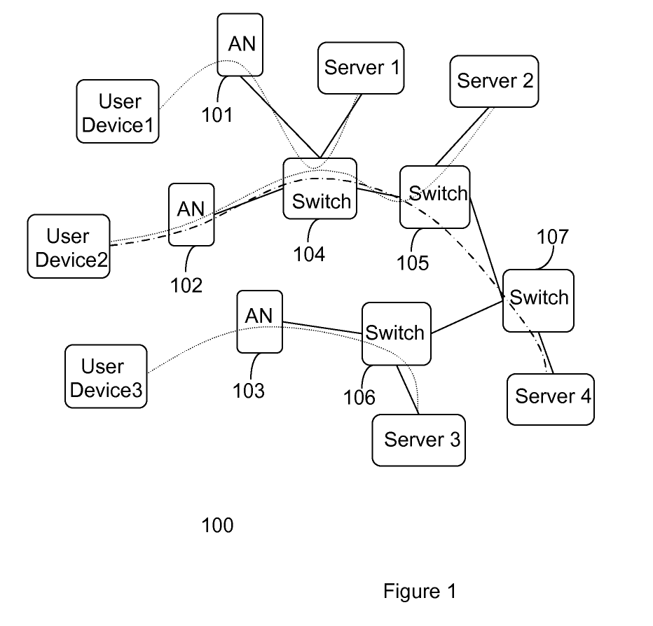

### DETAILED DESCRIPTION

Briefly described, the present document refers to an arrangement which, in association with a conventional DNS server functionality, is suitable for selecting one or more network elements, while taking various network related aspects into consideration during the selection process. The suggested arrangement is adapted to provide dynamic selection criteria, which provides a selection of IP-addresses in association with performing address resolving.

Although the exemplifications of this document relate to a mechanism for selecting IP-addresses, it is to be understood that the suggested mechanism is applicable also for other types of address spaces and address specifications.

The document also refers to a method to be applied in the suggested arrangement.

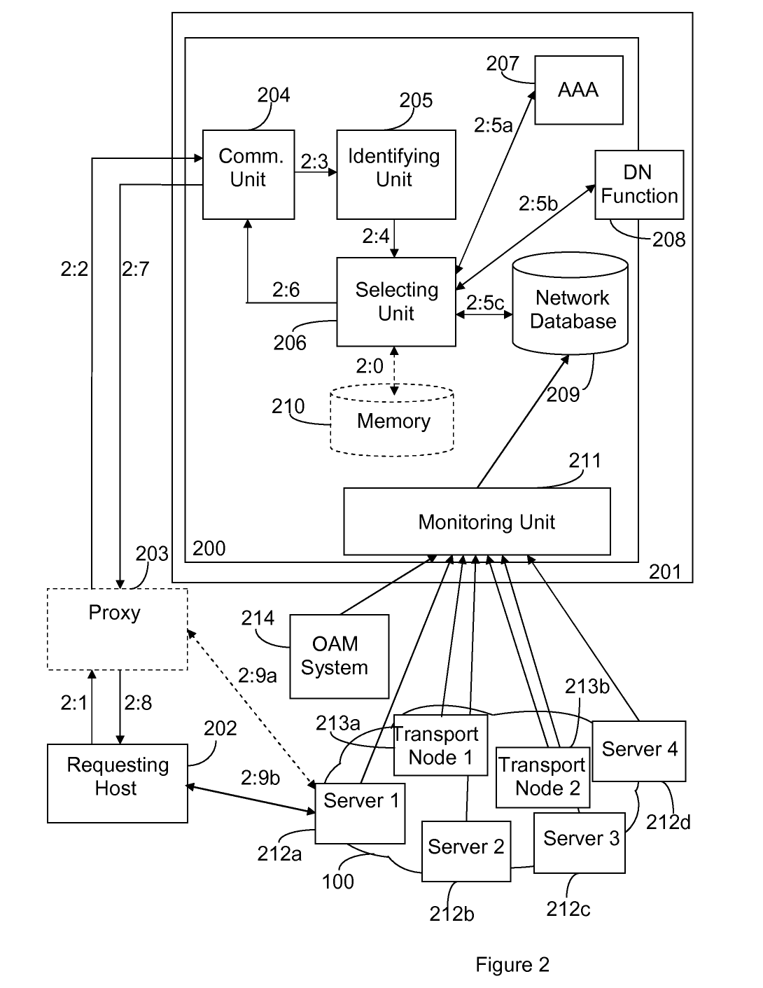

FIG. 2 is an illustration of an arrangement 200, which may be referred to as a selection arrangement, or more specifically, to an optimized selection arrangement, which is configured to provide an enhanced address resolving mechanism, which responds to an address resolving request by identifying and selecting one or more most appropriate network elements from which a requested content can be obtained. The proposed selection is performed on the basis of pre-defined selection criteria. This is achieved by making use of updated topology related network information which may be processed and combined in various ways for selecting one or more most appropriate network elements out of a set of network elements that have been identified in a previous step.

It is to be understood that a selected network element may be any kind of network element which offers content downloading, either from the very same network element, or from another network element on which the content is stored, e.g. by operating an intermediate network element or node.

In response to receiving a request for address resolving in association with a required downloading of downloadable content, which may e.g. refer to a movie, a game, one or more executable programs, or a piece of art, such as e.g. music, a painting, a photograph, a piece of literature, or any other documentation, arrangement 200 is adapted to select one or more network elements, which typically refers to one or more servers, such as e.g. Video on Demand (VoD) servers, from which the requested content can be accessed, either directly or indirectly.

The proposed arrangement 200 may either be implemented as a part of a DNS server 201 being part of a Domain Name System (DNS), i.e. as an enhanced DNS server as indicated in FIG. 2, or configured as a standalone entity, which is connected to a conventional DNS server. Thereby, in addition to provide conventional DNS functionality, the arrangement 200 provides an extended selection functionality that is configured to select the one or more most appropriate network element/s.

Once a network element has been selected, the IP-address of the selected network element is provided to the requesting host, or, if the requested item is to be downloaded from a plurality of different network elements, a list of relevant IP-addresses of these network elements is provided to the requesting host 202, which may be a mobile or non-mobile host. From hereinafter the term network element in singular is to be interpreted as meaning one or more network elements. In the same manner IP-address is to be interpreted as meaning one or more IP-addresses. Throughout the document IP address shall be interpreted to be any type of address representation.

It is further to be understood that the requesting host 202 may either be the entity on which the requested content is to be consumed, or it may be an entity, such as e.g. a server, operating on behalf of the entity on which the requested content is to be consumed.

Arrangement 200 is provided with selection logic that is adapted to select the one or more network elements that, according to pre-defined selection criteria, is/are most suitable for accessing the requested content, and to provide an IP address of each selected network element to the requesting host 202, directly, or via a proxy 203, as indicated in FIG. 2.

According to FIG. 2 a requesting host 202 may first trigger a Proxy 203, which may be operating on-behalf of the requesting host 202, to transmit an address resolving request to a conventional communication unit 204 of arrangement 200, as indicated with a first step 2:1, and a subsequent second step 2:2, respectively. Alternatively, the requesting host 202 transmits the request provided in step 2:2 directly to communication unit 204, without involving any intermediate proxy.

An address resolving request may be based on any type of conventional signaling, but in a typical embodiment DNS queries may be used for this purpose. The proposed selection arrangement 200 is configured to identify the requested service, as well as the requesting host 202 from content of the received address resolving request, from hereinafter referred to as request specific information. According to the exemplified configuration, this is achieved at an identifying unit 205 of arrangement 200.

If DNS queries are applied, service identification may be based on identification of a string of the query that has been encoded into the Fully Qualified Domain Name (FQDN) at the host in a conventional manner. If e.g. the FQDN is defined as “_inet.tcp.example.net”, “_inet” denotes the requested service.

According to another example where the FQDN has instead been defined as “Movie@svt.net”, the required content itself, i.e. “Movie”, can be identified by extracting the first part of the FQDN, while the source of the content can be identified by extracting the “svt.net” part from the FQDN.

The required host identifier, i.e. the parameter that enables the requesting host 202 to be identified, may e.g. be the IP address of the requesting host 202, if the requesting host is also the requestor.

According to one embodiment, the host identifier, which may be expressed as any type of text string, which has been pre-configured in the selection logic, may be encoded into the FQDN of the address resolving request. This embodiment may be implemented if the selection logic has been configured to handle and process static pre-configuration of hosts and their corresponding locations. Consequently, such a configuration is specifically suitable for identification of non-mobile hosts.

According to another, alternative embodiment, the host identifier may instead be transferred in an additional Resource Record (RR) field of the address resolving query. Also in this case, the host identifier may be any text string, including the IP address of the requesting host 202. In order to be able to identify the requesting host 202 according to the latter embodiment, the arrangement 200 needs to comprise functionality which enables a received request to be parsed. According to FIG. 2, the query is received by communication unit 204, as indicated with step 2:2, and subsequently by the identifying unit 205, which is adapted to identify the requesting host 202, typically according to any of the embodiments suggested above, as indicated with another step 2:3. The identifying unit 205 is also configured to identify one or more parameters, on the basis of the requested content and the identified requesting host 202.

Selecting arrangement 200 of FIG. 2 also comprises a selecting unit 206, hosting selection logic, which is adapted to fetch identified parameters from one or more data sources, and to process these parameters, according to pre-defined selection criteria, such that an optimized network element selection can be provided to the requesting host 202, in response to the request. For being able to apply such selection criteria, selecting unit 206 also have access to policy rules which have been configured to support the selection criteria to be applied. Such policy rules may typically be stored in the selecting unit 206, or in a storage (not shown) accessible by the selecting unit 206.

According to one embodiment, the policy rules may specify that only the network elements for which the total load is below a pre-defined threshold are selected, or the available capacity is above a predefined threshold, while other network policies may stipulate that selected IP-addresses are sorted in a pre-defined order.

The selection process is indicated as step 2:4, in combination with steps 2:5a-c, where the latter steps illustrate how identified information/parameters on the basis of which the selection will be based, can be collected from different data sources 207-209, respectively.

Selecting unit 206 has access to the identifying unit 205 which provides a list of selectable network elements, e.g. content servers that can provide a requested service, i.e. requested content, all according to known procedures of a conventional DNS server, to the selecting unit 206. If e.g. the requested item is a movie, the identifying unit 205 may provide a list of all VoD servers from which the requested movie can be downloaded to the selecting unit 206.

In addition, arrangement 200 may also have access to an Authentication, Authorization and Accounting (AAA) server 207, from where subscription and service related information may be collected, and used during the selection process.

Furthermore, arrangement 200 also comprises a Network Database 209, from which topology related network information, such as e.g. status-, functionality and/or capability information on transport nodes may be fetched by the selecting unit 206. The topology related network information is preferably dynamically updated. The network database 209 may be a standard relational database that has been implemented as an integrated part of the arrangement 200, as indicated in FIG. 2, while, according to an alternative embodiment it may instead be implemented as a separate entity that is associated with arrangement 200.

According to an alternative embodiment, the selecting unit 206 may be adapted to fetch and store identified topology related network information in advance, in addition to fetching relevant information, i.e. one or more parameters, only on demand, i.e. upon receiving an address resolving request.

Such a scenario may e.g. be applied for one or more popular and frequently received queries, in order to reduce the processing time of the arrangement 200 for this category of queries. The selecting unit may therefore also be adapted to statistically determine which queries that are most frequently received over a pre-defined time-interval and/or determine peak hours when certain queries are to be expected. The respective parameters that have been identified and fetched in advance may then be stored in an optional volatile memory means, as indicated with optional step 2:0, and optional memory 210, thereby enabling rapid access of the respective parameters.

The selection logic of selection unit 206 is adapted to process acquired parameter/s, constituting a subset of the topology related network information stored in the network database, according to applied selection criteria, such that an IP-address, or if the requested service is to be obtained from a plurality of different network elements, a list of IP-addresses, of the one or more selected network elements can be provided in response to the requesting host 202. The request is transmitted to the requesting host 202, via steps 2:6-2:7 and 2:8, or in case the is not involved via steps 2:6-2:7.

On the basis of the response provided from arrangement 200, the proxy 203, or the requesting host 202, may establish connection with the one or more selected network elements 212a-d, such as e.g. content servers, as indicated with alternative steps 2:9a and 2:9b, all according to conventional procedures. Alternatively the response provided in step 2:7 and 2:8 may be forwarded to another entity, in case the requesting unit and the unit which is to download content are not the same.

Arrangement 200 also comprises a unit, here referred to as a monitoring unit 211, which is adapted to control and monitor various types of network nodes, such as the potentially selectable network elements 212a-d, in the present example represented by content servers 1-4 as well as transport nodes 213a, 213b. It is to be understood that although network 100 of FIG. 2 only comprises four servers and two transport nodes, a typical network may comprise a large amount of these types of entities.

The monitoring unit 211 may also be adapted to enable access to additional network related information, including node internal performance parameters, such as e.g. information on load, failure, and/or hard disk usage. This type of information may be obtained from an Operation And Maintenance system (OAM) 214, which is interconnected to the monitoring unit 211.

The monitoring unit 211, is preferably adapted to poll network nodes of network 100, such as e.g. server 1-4 212a-212d and transport nodes 1-2 213a-213b, to get information about their current status. The polling may e.g. be performed in a round-robin manner, such that acquired information is up-to-date, according to the latest status.

Another alternative implementation is to set traps in the transport nodes, and let them actively send update status reports to the monitoring unit 211 whenever a respective status has changed or whenever a parameter has changed more than a predefined threshold or alternatively according to any other schedule possibly under control of a policy.

The monitoring unit 211 described above may comprise any kind of conventional functionality for feeding updated information to the network database 209.

It is to be understood that the units and functions mentioned above refers to logical units and functions, which merely describe one possible way of arranging the suggested functionality, and that other alternative system architectures which support the suggested selection mechanism may be applied.

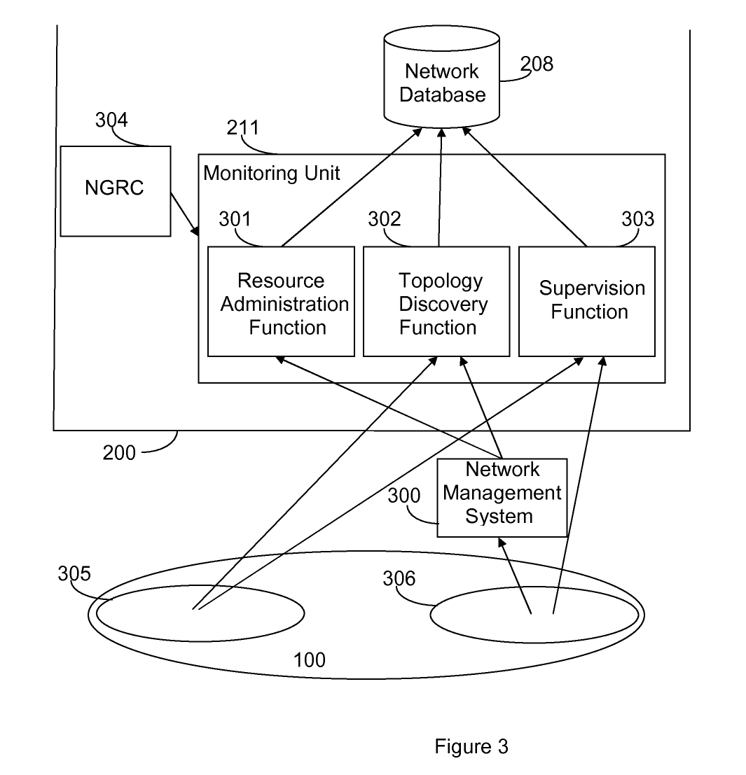

A more detailed description of the monitoring unit 211, which has been configured according to one exemplary embodiment, will now be described with reference to FIG. 3. According to FIG. 3, monitoring unit 211 may comprise one or more functions that are dedicated to monitor different types of topology related information from the network 100 hosting selectable network elements from which requested content can be downloaded and transport nodes that are adapted to transport content from the selectable network elements. In the present example such entities are represented by a resource administration function 301, a topology discovery function 302 and a supervision function 303.

In the present example a resource administration function 301 is referred to as a function which is adapted to support management of the transport resources of a network 100, such that a more equilibrated transport load and, thus, higher session completion ratios can be obtained in the network 100.

The resource administration function 302 is typically pre-configured by the network management system 300, based on information such as e.g. network operator policies and/or Service Level Agreement (SLA) information. In order to provide for information updates on dynamic changes in network transport resources, the resource administration function 302 may interface one or more entities, such as e.g. a resource control entity (NGRC). An NGRC is an entity that is in charge of resource management, such as e.g. a Policy and Charge Rules Function (PCRF), or a Home Subscriber Server (HSS) for retrieving subscription information.

The topology discovery function 302 is adapted to retrieve routing topology and link/router status information e.g. by listening to Open Shortest Path First (OSPF) advertisements generated by the network routers. Generalized Multiprotocol Label Switching (GMPLS)-aware nodes 305 may communicate updated topology information to the topology discovery function via Opaque-Link State Advertisements (LSAs), while GMPLS-unaware nodes 306 may use the network management system 300 to provide topology information to the topology discovery function 302.

A supervision function 303 provides the monitoring unit 211 with information on status, capability, such as e.g. VPN configurations, functionality and/or load for both the transport nodes and selectable elements such as servers or other nodes or pools of nodes of the network 100. Updates on GMPLS-aware nodes 305 may be performed in a similar manner as for the Topology discovery function 302, while updates on GMPLS-unaware nodes 306 may be achieved by using appropriate prior art technique, such as e.g. ping or Simple Network Management Protocol (SNMP).

According to one embodiment, the supervision function 303 may interface directly to the network nodes of network 100, while according to another embodiment, the supervision function 303 may instead obtain configuration information from the network management system 300, which can be adapted to poll the network 100.

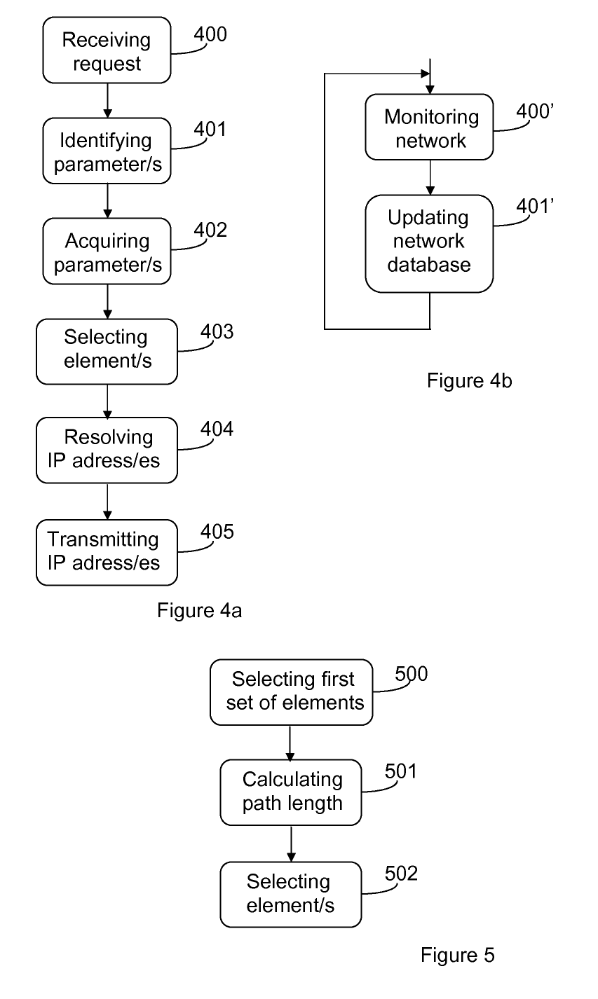

A method suitable for implementation in an arrangement such as the one described above, which enables a dynamic selection of network element/s, will now be described as a sequence of interrelated steps. According to one exemplary embodiment, which will now be described in more detail with reference to FIG. 4a, an address resolving request associated with a specific downloadable item is received, as indicated with a step 400.

The request may be provided by a requesting host via any type of conventional signaling, but may preferably be based on DNS queries. Since DNS is supported by a vast majority of IP hosts, the required impact on the functionality of the requesting unit will be low.

In addition, the standardized DNS features may be exploited in a conventional way, without requiring any modifications to the DNS functionality. In a next step 401, parameters that are required for the requested network element selection, at least some of which can be referred to as topology related information, are identified on the basis of the identity or address of the requesting host and other content of the request. The identified parameters are then acquired from one or more respective data sources, as indicated with another step 402. In case data has been acquired in advance for the request, the identified parameters may instead be obtained from a memory means.

The identified parameters may comprise server or pool identification information, i.e. information on the network elements from which the requested item may be downloaded, and is typically provided as a list of network elements. Further the identified parameters may comprise additional information that relates e.g. to topology, status, availability or capability of the transport nodes of the network. In addition, information on a specific requested item, such as information on the distribution of the requested item on different network elements of a network, may be accessible from an OAM system via a monitoring unit and a network database.

Once the identified parameters have been acquired, one or more network elements are selected by applying selection logic, which has been configured for this purpose, as indicated with a step 403. The selection logic is adapted to process a pre-defined optimization algorithm, which is based on specific selection criteria, i.e. one of, or a combination, of rules and policies, using the identified parameters as input data. In a next step 404, the IP-addresses of the one or more selected network elements are resolved by acquiring DNS functionality.

In a final step 405 the outcome from the selection step, i.e. one or more IP-addresses, each associated with a selected network element, is/are transmitted to the requesting host. The requesting host, or any other entity to which the one or more IP-address is to be forwarded, may then use the IP-addresses for downloading purposes in a conventional manner.

In parallel to the method steps of FIG. 4a, the topology related network information of the network database may be monitored and updated by a monitoring unit. According to one exemplary embodiment, described with reference to FIG. 4b, an updating procedure may be executed by monitoring the communication network (100), i.e. by dynamically acquiring topology related network information associated with network elements and nodes of communication network (100), as indicated with a step 400′, and by updating the network database with monitored, updated network information, as indicated with a next step 401′.

FIG. 5 illustrates a specific example where network element selection is based on minimum cost. In such a scenario, step 403 of FIG. 4 may be extended to disclose the following three sub steps.

In a first selection sub step, step 500, a first set of network elements from which the requested content can be downloaded, are selected on the basis of acquired network information. In a next selection sub step 501, path lengths required for accessing the requested content are calculated for the selected subset of network elements, and in a third selecting sub step 502, at least one network element of the selected subset of network elements which enables downloading of the requested content at a minimum cost is selected.

As already indicated above, the selection logic may base its selection of one or more preferred network elements on different combinations of updated parameters. These parameters may e.g. refer to topology related parameters, such as parameters indicating the locations of a certain category of network elements from which a requested item can be obtained; parameters describing an available transport topology, or an IP-addressing topology.

The proposed selection mechanism may be implemented as a computer program product, which is directly loadable into a memory means of arrangement 200, comprising software code portions which have been adapted to perform method steps according to any of the examples suggested above, when the computer program product is run on arrangement 200.

Performance related parameters, may contribute e.g. with load and/or capacity information on a certain system of network elements, but also with information on the possibility to use certain network elements for transmitting downloadable content. Performance related parameters may e.g. provide information that a network element is presently out-of-order or un-reachable, due to a fault in the network.

Subscription related parameters, i.e. parameters associated with the relevant subscription/s, which allow a requesting host to download a specific item, may include a list of network elements from which a requested item can be downloaded and/or a classification list, where different items may have been appointed different classes, e.g. different price-level classes. Selection may then be performed on the basis of these classes.

One possible selection criterion, which will now be given as an example, may be based on load and minimum costs. According to this exemplified criterion all possible network elements, from which the requested item can be obtained, are first selected. Next, additional information on the selected group of network elements is obtained and considered, by identifying and acquiring relevant parameters. This information may typically comprise classification information, and topology information. The selection algorithm may include the execution of a cost estimation, aiming at finding the shortest path, i.e. the path which requires the minimum number of hops for reaching a network element from which required content can be downloaded. The selection algorithm may further include the execution of a delay estimation, aiming at finding the path which renders a lowest delay in connection to the downloading of the requested content. A further selection algorithm may include the execution of a load estimation of the transport nodes, aiming at finding the path which renders a lowest load in connection to the downloading of the requested content. And further the selection may aim at finding the most suitable coding quality. Next the network element, or elements if more than one network element is required, is/are selected, which enables the selected content to be downloaded via the most optimal path according to the selection algorithm.

Another selection criterion which may be referred to as a shortest path selection is based on an algorithm that is used for determining the next-hop to forward the packet. The algorithm selecting the path minimizes the overall cost, where the cost is estimated as the number of hops and the sum of the inverse bandwidth, such that links with the highest bandwidths are selected first.

Another selection criterion which is focusing on determining a minimized average load may instead rely on information on the overall load on all links in the network, which may be maintained in the network database. By using a global view, the most un-loaded link path can be selected by calculating the average load on the link path.

According to another alternative embodiment, which is specifically suitable for considering additional content such as e.g. advertisements that may be provided together with downloadable content, network elements that are specifically assigned to contain advertisements may preferably be selected. Information on the additional content, such as e.g. time between advertisements, can then be inserted into the list of IP-addresses provided to the requesting host. In case the requesting host is later downloading content from a selected network element in a specific order, the additional content e.g. advertisements, can be automatically inserted at specific locations in the fetched content, such that, upon consumption of the downloaded content, also the additional content is provided in a preferred order.

While the described method and arrangement have been described with reference to specific exemplary embodiments, the description is generally only intended to illustrate the inventive concept and should not be taken as limiting the scope of the described concept, which is defined by the appended claims.

### ABBREVIATIONS

AAA Authentication, Authorization and Accounting

DNS Domain Name System

FQDN Fully Qualified Domain Name

GGSN Gateway GPRS Support Node

GMPLS Generalized Multiprotocol Label Switching

GPRS General Packet Radio Service

IP Internet Protocol

LSA Link State Advertisements

OAM Operation And Maintenance

OSPF Open Shortest Path First

PCRF Policy and Charging Rules Function

RR Resource Records

SNMP Simple Network Management Protocol

VoD Video on Demand

1.-15. (canceled)

16. A Domain Name System (DNS) server configured to provide to a requesting host one or more addresses of one or more network elements from which the requesting host is able to download requested content, the DNS server comprising:
a communication unit configured to receive an address resolving request from the requesting host, the request including request specific information on the requested content and the requesting host;
a network database containing topology related network information of the communication network;
an identifying unit configured to identify a subset of the network information based on the received request specific information;
a selecting unit configured to:
acquire the identified subset of network information;
select the one or more network elements based on the acquired subset of network information and the request specific information;
resolve one or more addresses for each of the one or more network elements;
the communication unit being further adapted to transmit the one or more addresses to the requesting host in a response message.

17. The DNS server of claim 16 wherein:
the identifying unit is configured to identify a topological location of the requesting host based on the request specific information;
the selecting unit is configured to select the one or more network elements at least partly based on the topological location.

18. The DNS server of claim 16 wherein the network information comprises at least one of:
subscription related information associated with the requesting host;
service related information associated with the requesting host;
information related to at least one of the one or more network elements from which the requested content is downloadable;
capability and link status related information of the available transport nodes.

19. The DNS server of claim 16 wherein the selecting unit is configured to select the one or more network elements by executing predefined selection criteria and using the acquired subset of network information as input data.

20. The DNS server of claim 16 further comprising a monitoring unit that is configured to:
dynamically acquire topology related network information associated with the communication network;
update the network database based on the dynamically acquired information.

21. The DNS server of claim 20 wherein the monitoring unit comprises at least one of one of:
a topology discovery function configured to acquire changes to at least one of routing topology information and link status information on transport nodes of the communication network;
a supervision function configured to acquire changes to at least one of status, capability, functionality and load information of the transport nodes and network elements of the communication network;
a resource administration function configured to acquire updated transport resource information of the transport nodes of the communication network.

22. The DNS server of claim 16 wherein the selecting unit is further configured to implement one or more of:
calculate, based on the identified subset of network information, the number of hops required for downloading the requested content, and further base the selection of one or more network elements on the calculated number of hops required for downloading the requested content;
calculate, based on the identified subset of network information, the delay in connection to the downloading of the requested content, and further base the selection of one or more network elements on the calculated delay in connection to the downloading of the requested content;
calculate, based on the identified subset of network information, the load of the network elements, and further base the selection of one or more network elements on the calculated load of the network elements;
calculate, based on the identified subset of network information, the capacity of the network elements, and further base the selection of one or more network elements on the calculated capacity of the network elements;
select the one or more network elements further based on the coding quality of the requested content downloadable from the network elements;
select the one or more network elements further based on additional content downloadable from the network elements.

23. The DNS server of claim 16 wherein the selecting unit is further adapted to sort the one or more resolved addresses into a pre-selected order.

24. The DNS server of claim 16 wherein the one or more network elements are Video on Demand (VoD) servers.

25. A method, in a communication network, for providing to a requesting host one or more addresses of one or more network elements from which the requesting host is able to download requested content, the method being implemented by a Domain Name System (DNS) server and comprising:
receiving an address resolving request from the requesting host, the request comprising request specific information on the requested content and the requesting host;
identifying, from topology related network information stored in a network database, a subset of network information based on the received request specific information;
acquiring the identified subset of network information;
selecting one or more network elements based on the acquired subset of network information and the request specific information;
resolving one or more addresses for each of the one or more network elements;
transmitting the one or more addresses to the requesting host in a response message.

26. The method of claim 25 further comprising:
dynamically acquiring topology related network information associated with the communication network;
updating the network database based on the dynamically acquired information.

27. The method of claim 25:
wherein identifying the subset of network information comprises acquiring the topological location of the requesting host;
wherein selecting of one or more network elements comprises selecting the one or more network elements at least partly based on the acquired topological location.

28. The method of claim 25 wherein selecting one or more network elements comprises one or more of the following:
calculating, based on the identified subset of network information, the number of hops required for downloading the requested content, wherein the selecting of one or more network elements is further based on the calculated number of hops required for downloading the requested content;
calculating, based on the identified subset of network information, a delay in connection to the downloading of the requested content, wherein the selecting of one or more network elements is further based on the calculated delay in connection to the downloading of the requested content;
calculating, based on the identified subset of network information, the load of the network elements, wherein the selecting of one or more network elements is further based on the calculated load of the network elements;
calculating, based on the identified subset of network information, the capacity of the network elements, wherein the selecting of one or more network elements is further based on the calculated capacity of the network elements;
selecting the one or more network elements further based on the coding quality of the requested content downloadable from the network elements;
selecting the one or more network elements further based on additional content downloadable from the network elements.

29. The method of claim 25 wherein the requested content includes one or more of a movie, a game, one or more executable programs, a piece of music, a painting, a photograph, and a piece of literature.

30. A computer program product directly stored in a non-transitory computer-readable medium of a Domain Name System (DNS) server, the computer program product comprising computer code which, when run on the DNS server, configures the DNS server to:
receive an address resolving request from the requesting host, the request comprising request-specific information on the requested content and the requesting host;
identify, from topology related network information stored in a network database, a subset of network information, based on the received request specific information;
acquire the identified subset of network information;
select one or more network elements based on the acquired subset of network information and the request-specific information;
resolve one or more addresses for each of the one or more network elements;
transmit the one or more addresses to the requesting host in a response message.
